(19) United States
(12) Patent Application Publication
(10) Pub. No.: US 2006/0013133 A1
(43) Pub. Date: Jan. 19, 2006

(54) Packet-aware time division multiplexing switch with dynamically configurable switching fabric connections

(76) Inventors: Wang-Hsin Peng, Ottawa (CA); Craig Suitor, Nepean (CA); Louis Pare, St. Bruno (CA); Wai-Chau Hui, Kanata (CA); David Yeung, Nepean (CA)

Correspondence Address: SMART AND BIGGAR, 438 UNIVERSITY AVENUE, SUITE 1500 BOX 111, TORONTO, ON, M5G2K8, CA

(21) Appl. No.: 10/892,118

(22) Filed: Jul. 16, 2004

(51) Int. Cl. H04L 12/26; H04L 12/28; H04L 12/56

(52) U.S. Cl. 370/230; 370/235; 370/294; 370/434

(57) ABSTRACT

A packet-aware time division multiplexing (TDM) switch includes one or more ingress ports, one or more egress ports, a TDM switching fabric, and a bandwidth manager. Ingress ports are capable of distinguishing packets. The TDM switching fabric has persistent connections which provide connectivity between each ingress port and each egress port. Packets received at an ingress port are transmitted to one or more egress ports using TDM over one or more switching fabric connections. The congestion of each connection is monitored, and the capacity of the connection may be automatically adjusted based on the monitored congestion. Congestion may be indicated by a utilization of the connection or by a degree to which a buffer for storing packets to be sent over the connection is filled. Statistical multiplexing may be used at ingress ports and/or egress ports in order to eliminate idle packets. The utilization of the switch for data traffic may thus be improved over conventional TDM switches.

### FIELD OF THE INVENTION

The present invention relates to telecommunications switching equipment, arid more particularly to telecommunications switching equipment capable of switching data traffic over a switching fabric using time division multiplexing.

### BACKGROUND OF THE INVENTION

The public switched telephone network (PSTN) is a concatenation of the world's public circuit-switched telephone networks. The basic digital Circuit in the PSTN is a 64 kilobit-per-second (kbps) channel called a Digital Signal 0 (“DS-0”) channel (the European and Japanese equivalents are known as “E-0” and “J-0” respectively). DS-0 channels are sometimes referred to as timeslots because they are multiplexed together using time division multiplexing (TDM). As known to those skilled in the art, TDM is a type of multiplexing in which data streams are assigned to different time slots which are transmitted in a fixed sequence over a single transmission channel. Using TDM, multiple DS-0 channels are multiplexed together to form higher capacity circuits. For example, in North America, 24 DS-0 channels are combined to form a DS-1 signal, which when carried on a carrier forms the well-known T-carrier system “T-1”.

In the PSTN, DS-0 channels are conveyed over a set of equipment commonly known as the access network. The access network and inter-exchange transport of the PSTN use Synchronous Optical Network (SONET) technology, although some parts still use the older pleisiochronous digital hierarchy (PDH) technology.

At individual nodes of the PSTN, switches are responsible for switching traffic between various network links. Many switches in the PSTN perform this switching on a TDM basis, and are thus referred to as “TDM switches”. Conventional TDM switches operate at Open System Interconnection (OSI) Layer 1 (i.e. the physical layer).

TDM switches have at their core a TDM switching fabric, which is a switching fabric that switches traffic between the input and egress ports of the switch on a time slot basis. In a conventional TDM switch, traffic is transmitted through the fabric using connections. A “connection” is a reserved amount of switching fabric capacity (e.g. 1 gigabit/sec) between an ingress port and an egress port. Typically, connections are pre-configured in the fabric (i.e. set up before voice or data traffic flows through the switch) between selected ingress and egress ports based on an anticipated amount of required bandwidth between the ports. Not every ingress port is necessarily connected to every egress port. Connections are persistent, i.e., are maintained throughout switch operation, and their capacity does not change during switch operation.

When traffic flows through a conventional TDM switch, it is typically switched through the TDM switching fabric as follows: at time interval 0, a number of bits representing voice or data information from a first channel are transmitted across one connection; at time interval 1, a number of bits representing voice or data information from a second channel are transmitted across another connection; and so on, up to time interval/connection N; then beginning at time interval N+1, the process repeats, on a rotating (e.g. round robin) basis. In some cases, bits may be transmitted in parallel during the same time interval over multiple connections which do not conflict. The “channels” providing the bits for transmission may for example be SONET VT-1.5 (Virtual Tributary) signals, which transport a DS-1 signal comprising 24 DS-0's, all carrying voice or all carrying data. The duration of the time interval is set based on the number of connections in the fabric and the bandwidth needed by each connection. Operation of the TDM switching fabric is thus deterministic, in the sense that, simply by knowing the current time interval, the identity of the channel whose information is currently being transmitted across the fabric can be determined.

When a DS-0 channel is used to carry a voice signal (e.g. a telephone conversation between a calling party to a called party), audio sound is usually digitized at an 8 kHz sample rate using 8-bit pulse code modulation (PCM). PCM digitization is normally performed even during moments of silence during a conversation. As a result, the rate of data transmission for a voice signal over a DS-0 channel (and over collections of DS-0's, such as a DS-1 channel) is generally steady.

Given the steady data rate of voice signals, and because voice calls tend to be placed according to generally predictable distributions (e.g. Erlang distributions), voice signals are generally well-suited for switching by TDM switches, given the pre-configured, deterministic operation of such switches, as described above.

Some DS-0/DS-1 channels carry data rather than voice signals. In this context the term “data” refers to packet-switched traffic, such as Internet traffic using to the TCP/IP protocol for example. The data carried over a single DS-0 channel may consist of packets from a number of different flows (e.g. packets from a number of Internet “sessions”), as may be output by a router. Routers of course operate at OSI Layer 2 (the data link layer), as they are “packet-aware”.

For example, a router wishing to send data traffic to another router may use a Metro Area Network (MAN) or Wide Area Network (WAN) for this purpose. The MAN or WAN may be comprised of a number of TDM switches. The data traffic (packets) may comprise one or more DS-0 channels that are switched by one or more TDM switches along their journey to the remote router.

When a DS-0 channel carries data traffic, some of the packets may not actually carry valid data, but may instead be padded with zeroes or other “filler” data. Such packets are referred to as “idle” packets. Idle packets may be automatically generated within a flow, for “keep alive” purposes for example.

When a conventional TDM switch switches data traffic, it operates in the same manner as when it switches voice traffic, i.e., deterministically and based on pre-configured switching fabric connections. That is, conventional TDM switches dutifully switch bits from ingress ports to egress ports, as described above, regardless of whether the bits represent voice or data, and in the case of data, regardless of whether the packets are “real” packets or idle packets. Indeed, a conventional TDM switch does not distinguish packets at all, given that it operates at OSI Layer 1 and not OSI Layer 2.

Data traffic characteristics are usually quite different from voice traffic characteristics. Whereas voice traffic is generally steady, data traffic tends to consist of brief bursts of large amounts of data separated by relatively long periods of inactivity. As a result, conventional TDM switches may, disadvantageously, be ill-suited for switching data traffic. In particular, a conventional TDM switch responsible for switching data traffic may be underutilized, for the following reasons: in order for a connection in the switching fabric of a conventional TDM to have sufficient capacity to handle a sudden burst of data, the connection may need to be pre-configured with a very large capacity (e.g. in the terabit/sec range). This capacity may be largely unused between data bursts. Some data may flow across the connection between bursts, but this may consist largely of idle packets, which the TDM switching fabric nevertheless dutifully transmits. Moreover, because the capacity of the connection is reserved for use by only that connection, unused capacity cannot be used by other connections in the fabric, and is thus wasted.

The above noted disadvantages may also apply to TDM switches used in private telephone networks which are not linked to the PSTN.

As the proportion of data traffic carried by the PSTN and similar private telephone networks continues to rise, utilization of TDM switches is reaching new lows. In some cases, utilization of TDM switches is as low as 10 to 30%.

It may be possible to address TDM switch underutilization by replacing or supplementing TDM switches with routers, which are designed for efficient packet traffic switching. However, this approach may result in significant equipment expenditures.

### SUMMARY OF THE INVENTION

A packet-aware time division multiplexing (TDM) switch includes one or more ingress ports, one or more egress ports, a TDM switching fabric, and a bandwidth manager. Ingress ports are capable of distinguishing packets. The TDM switching fabric has persistent connections which provide connectivity between each ingress port and each egress port. Packets received at an ingress port are transmitted to one or more egress ports using TDM over one or more switching fabric connections. The congestion of each connection is monitored, and the capacity of the connection may be automatically adjusted based on the monitored congestion. Congestion may be indicated by a utilization of the connection or by a degree to which a buffer for storing packets to be sent over the connection is filled. Statistical multiplexing may be used at ingress ports and/or egress ports in order to eliminate idle packets. The utilization of the switch for data traffic may thus be improved over conventional TDM switches.

Advantageously, legacy TDM switches may be upgraded to become capable of distinguishing packets and of dynamically reallocating switching fabric bandwidth as described herein. As a result, the efficiency of legacy TDM switching equipment in switching data traffic may be increased to avoid any need to replace or supplement this equipment with packet-based routers. Telecommunications switching equipment upgrade costs may therefore be kept in check.

In accordance with an aspect of the present invention there is provided apparatus for use with a TDM switch, comprising: an ingress port for connection to a TDM switching fabric, the ingress port comprising a controller for obtaining an indication of congestion for a connection through the TDM switching fabric and for, if the congestion indication falls outside an acceptable range, sending a request to adjust a capacity of the connection.

In accordance with another aspect of the present invention there is provided a switch comprising: a plurality of ingress ports capable of receiving and distinguishing packets, the receiving and distinguishing resulting in arrived packets; a plurality of egress ports; a switching fabric having persistent connections interconnecting each of the ingress ports with each of the egress ports, the connections capable of transmitting the arrived packets from the ingress ports to the egress ports using time division multiplexing, each of the connections having a capacity; and a controller for automatically adjusting the capacity of a connection in the switching fabric based on a measure of congestion for the connection.

In accordance with yet another aspect of the present invention there is provided apparatus for use in TDM switching of bursty data traffic, comprising: a switching fabric capable of providing persistent connections interconnecting each of a plurality of ingress ports with each of a plurality of egress ports, the connections for transmitting packets received at the ingress ports to the egress ports using time division multiplexing, each of the connections having a capacity that is automatically adjustable based on an indication of congestion for the connection.

In accordance with still another aspect of the present invention there is provided a method of switching packets over a switching fabric using time division multiplexing, comprising: receiving packets at one or more ingress ports; for each packet received at an ingress port: determining a destination egress port for the packet; and using time division multiplexing, transmitting the packet over a switching fabric connection interconnecting the ingress port with the destination egress port; and for each connection in the switching fabric interconnecting an ingress port with an egress port: periodically measuring congestion of the connection; and automatically adjusting a capacity of the connection based on the measuring.

In accordance with yet another aspect of the present invention there is provided a computer-readable medium storing instructions which, when executed by a switch, cause the switch to: receive packets at one or more ingress ports; for each packet received at an ingress port: determine a destination egress port for the packet; and using time division multiplexing, transmit the packet over a switching fabric connection interconnecting the ingress port with the destination egress port; and for each connection in the switching fabric interconnecting an ingress port with an egress port: periodically measure congestion of the connection; and automatically adjust a capacity of the connection based on the periodic measuring.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate example embodiments of this invention:

FIG. 1 is a schematic diagram illustrating a telecommunications network;

FIG. 2 illustrates a switch in the telecommunications network of FIG. 1 which is exemplary of an embodiment of the present invention;

FIG. 3 illustrates operation for receiving voice or data traffic at an ingress port of the switch of FIG. 2;

FIG. 4 illustrates operation for generating a connection capacity adjustment request at an ingress port of the switch of FIG. 2;

FIG. 5 illustrates operation for responding to a connection capacity adjustment request at the bandwidth manager of the switch of FIG. 2;

FIG. 6 illustrates operation for effecting a connection capacity adjustment at an ingress port of the switch of FIG. 2; and

FIG. 7 illustrates operation for effecting a connection capacity adjustment at an egress port of the switch of FIG. 2.

### DETAILED DESCRIPTION

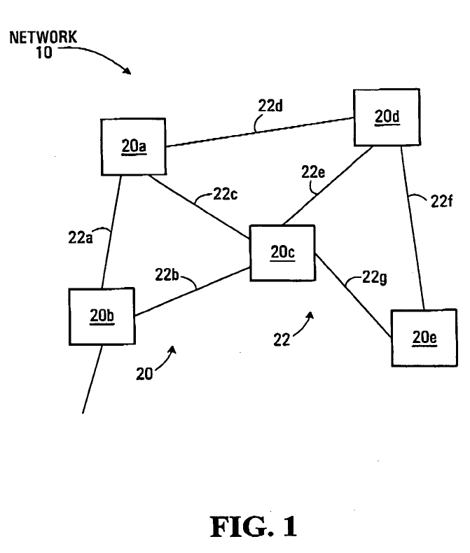

Referring to FIG. 1, a telecommunications network is illustrated generally at 10. The network 10 may be a portion of the PSTN or similar telephone network. The network 10 has a number of links 22a-22g (cumulatively links 22) interconnecting a number of switches 20a-20e (cumulatively switches 20). Links 22 are physical interconnections comprising optical fibres capable of transmitting traditional circuit-switched traffic (referred to as “voice traffic”) or packet-switched traffic (referred to as “data traffic”) by way of the Synchronous Optical Network (SONET) standard. Switches 20 are packet-aware TDM switches responsible for switching traffic between the links 22. Switches 20 are exemplary of embodiments of the present invention.

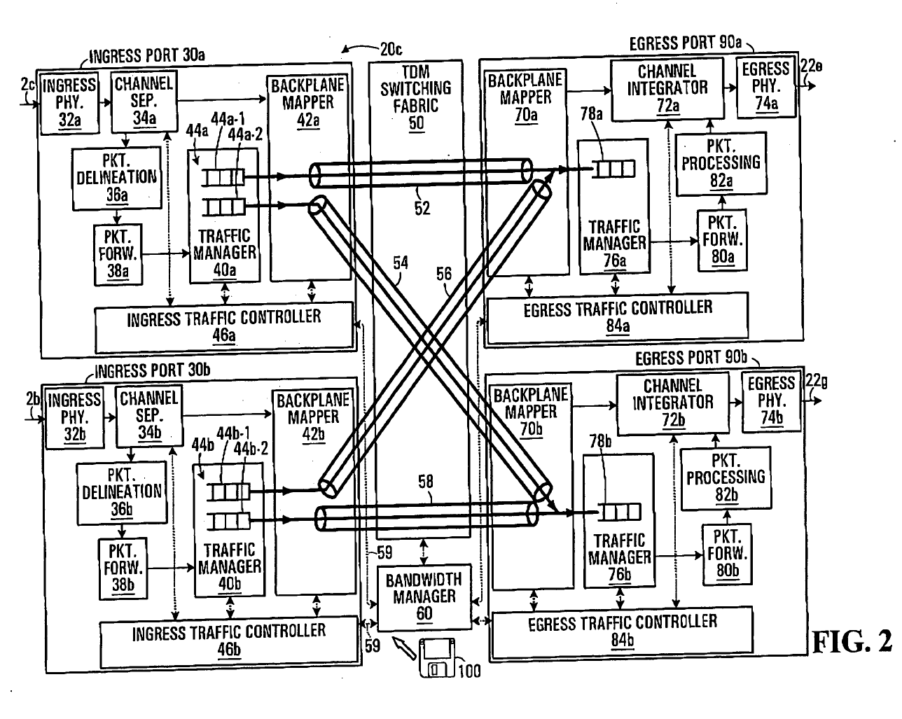

FIG. 2 illustrates an exemplary switch 20c in greater detail. The other switches of FIG. 1 (i.e. switches 20a, 20b, 20d and 20e) have a similar structure.

As shown in FIG. 2, switch 20c includes two ingress ports 30a and 30b, two egress ports 90a and 90b, a TDM switching fabric 50, and a bandwidth manager 60.

Ingress ports 30a and 30b are network switch ports responsible for receiving inbound traffic from network links 22c and 22b (respectively) and forwarding that traffic to TDM switching fabric 50 for transmission to an appropriate egress port 90a or 90b. Inbound traffic is received in the form of groups of 28 DS-1 time division multiplexed channels carried by SONET OC-1/STS-1 signals. The traffic may be either voice or data traffic. Channels at or below the SONET VT-1.5 level of granularity (e.g. DS-1, which corresponds to VT-1.5, or DS-0, which comprises DS-1) carry either all voice or all data traffic. In the case of voice, traffic on a single DS-0 channel may consist of audio sound digitized at an 8 kHz sample rate using 8-bit pulse code modulation (PCM. In the case of data, the traffic on a single DS-0 channel may consist of packets from a number of different flows (e.g. different Internet sessions) as may be output by a router for example. For clarity, the term “packet” as used herein is understood to refer to any fixed or variable size grouping of bits. The packets may conform to the well known TCP/IP or Ethernet protocols for example. Each flow may be identified by a unique ID.

Ingress ports 30a and 30b each perform various types of processing on traffic received from links 22c and 22b, which processing generally includes: separating inbound packets from incoming traditional circuit-switched voice traffic; determining a destination egress port for each received packet; buffering packets; and sending voice and data traffic to TDM switching fabric 50 for transmission to an appropriate egress port 90a or 90b. Separation of inbound data traffic (i.e. packet traffic) from traditional circuit-switched voice traffic is performed because data traffic and circuit-switched traffic are handled differently by the TDM switch 20c. Circuit-switched traffic is transmitted over the TDM switching fabric 50 in a conventional manner (with certain exceptions which will become apparent), while data traffic is processed on a per-packet basis and then transmitted over the TDM switching fabric 50. It is the processing and transmission of data traffic over fabric 50 (i.e. the switching of data traffic) which is the focus of the present discussion.

Processing at each of ingress ports 30a and 30b also includes the following: monitoring of both the utilization of connections within the fabric 50 over which packets are transmitted and the fill of buffers used to store incoming packets; periodic generation of bandwidth adjustment requests based on this monitoring; transmission of the requests to the bandwidth manager 60; processing of responses from bandwidth manager 60 authorizing/denying the requests; and, if authorized, adjusting the size of connections through the TDM switching fabric 50. The purpose of this processing is to support dynamic reallocation of capacity in TDM switching fabric 50 among connections on an as-needed basis.

Egress ports 90a and 90b are network switch ports responsible for receiving switched traffic from TDM switching fabric 50 and for transmitting that traffic to the next node in network 10 over network links 22e and 22g (respectively). The egress ports 90a and 90b are essentially mirror images of ingress ports 30a and 30b, with a some exceptions, as will become apparent. The traffic received from the TDM switching fabric 50 at egress ports 90a and 90b may be from either or both of ingress ports 30a and 30b. Egress ports 90a and 90b each perform processing on switched data traffic which generally includes buffering packets and merging outgoing packets with circuit-switched voice traffic. Egress ports 90a and 90b each also engage in processing to support dynamic reallocation of switching fabric capacity among switching fabric connections, which processing is triggered by out-of-band control messages received from ingress ports over switching fabric connections.

It should be appreciated that, while only two ingress ports 30a and 30b and two egress ports 90a and 90b are illustrated in FIG. 2, this is to avoid excessive complexity in exemplary switch 20c. In a typical embodiment, the actual number of ingress ports and egress ports may be much greater than two. As well, while only ingress ports are shown connected to links 22b and 22c and only egress ports are shown connected to links 22c and 22g, it is more typical for at least one ingress port and at least one egress port to be connected to each link with which a switch is connected.

TDM switching fabric 50 is-a switching fabric which is capable of transmitting either traditional circuit-switched traffic or data traffic from any ingress port 30a or 30b to any egress port 90a or 90b, on a TDM basis. The switching fabric 50 has an overall capacity (i.e. bandwidth, which may be 40 gigabits/sec for example) which is comprised of multiple physical paths. These paths, which may be envisioned as fixed-size “chunks” of bandwidth (e.g. 51.84 megabits/sec each—sufficient to carry a SONET STS-1 signal), are allocated to a number of connections 52, 54, 56 and 58. More specifically, each connection is comprised of a number of physical paths through the switching fabric 50 which have been grouped together using virtual concatenation (as will be described). A connection exists between each ingress port 30a, 30b and each egress port 90a, 90b. Unallocated bandwidth is maintained in a bandwidth pool, which may be implemented in the form of a memory map indicative of available bandwidth in TDM switching fabric 50. The allocation of bandwidth between the connections and the pool is initially pre-configured prior to the flow of traffic through the switch, and is later dynamically adjusted during the flow of traffic through the switch, or the basis of allocations made by the bandwidth manager 60, which allocations are based on the monitored utilization of the connections in fabric 50 and/or fill of ingress port buffers used to store incoming packets. The TDM switching fabric 50 additionally carries out-of-band control messages exchanged between ingress ports and egress ports during connection capacity adjustments. Switching fabric 50 may alternatively be referred to as a “backplane”.

Bandwidth manager 60 is a module which manages the allocation the physical paths (i.e. the aforementioned bandwidth chunks) through TDM switching fabric 50 among connections 52, 54, 56 and 58. When traffic flows through TDM switch 20c, bandwidth manager 60 periodically receives requests from ingress ports 30a and 30b to adjust the capacity of one or more of connections 52, 54, 56 and 58 on the basis of connection utilization and/or buffer fill, as monitored by the ingress ports. The bandwidth manager 60 is responsible for determining whether the requested connection capacity adjustments are in fact realizable and, if adjustment is possible, for identifying “chunks” of bandwidth that can be added to or removed from connections in need of a capacity adjustment. Bandwidth manager 60 communicates with TDM switching fabric 50 in furtherance of its responsibilities. The determination of whether or not a bandwidth adjustment will be possible is made in accordance with a scheduling allocation algorithm which strives to allocate bandwidth fairly among the connections, as will be described. Bandwidth manager 60 is also responsible for signalling the requesting ingress port 30a or 30b to indicate whether requested adjustments will be possible. Requests from, and responses to, ingress ports 30a, 30b are communicated between the bandwidth manager 60 and ingress ports 30a, 30b over a control interface 59, which may be a bus for example. Communication over control interface 59 is represented in FIG. 2 using a dashed line. The dashed line is a convention used herein to represent control information, as distinguished from network traffic (i.e. voice or data), which is represented using solid lines.

The operation of switch 20c may be controlled by software loaded from a computer readable medium, such as a removable magnetic or optical disk 100, as illustrated in FIG. 2.

Examining the first ingress port 30a in closer detail, it may be seen in FIG. 2 that the port 30a has various components including: an ingress physical interface (“PHY”) 32a, a channel separator 34a, a packet delineator 36a, a packet forwarder 38a, a traffic manager 40a, a backplane mapper 42a, and an ingress traffic controller 46a. The other port 30b has a similar structure (with an ingress PHY 32b, a channel separator 34b, a packet delineator 36b, a packet forwarder 38b, a traffic manager 40b, a backplane mapper 42b, and an ingress traffic controller 46b).

Ingress PHY 32a is a component responsible for the low-level signalling involved in receiving TDM-based voice and data traffic over network link 22c. Ingress PHY 32a may be referred to as an “L1 interface” as it is responsible for processing of signals at OSI layer 1 (“L1”). The ingress PHY 32a of the present embodiment supports the OC-1 and STS-1 interfaces.

Channel separator 34a is a component responsible for separating circuit-switched voice traffic and packet-switched data traffic received from ingress PHY 32a into two separate data streams. Voice traffic is separated from data traffic on a channel by channel basis. In the present embodiment, each channel is a VT-1.5 channel. The determination of which channels carry voice and which channels carry data is made prior to switch operation, e.g. by a network technician. The channel separator 34a is pre-configured to separate channels according to this determination. Separation of voice channels from data channels permits circuit-switched voice traffic to be conveyed to, and transmitted across, the TDM switching fabric 50 using conventional techniques, while the packet traffic is handled separately, as will be described.

Packet delineator 36a is a delineation engine which receives a packet traffic stream from channel separator 34a and delineates the stream into individual packets. The types of packet delineation that may be supported include the well-known High-level Data Link Control (HDLC), Ethernet delineation, and Generic Framing Procedure (GFP) delineation for example.

Packet forwarder 38a is a component generally responsible for receiving packets from the packet delineator 36a, classifying packets based on priority (e.g. based on a Quality of Service (QoS) specified in each packet), and forwarding undiscarded packets to traffic manager 40a Packet forwarder 38a may be an integrated circuit for example.

Traffic manager 40a is a component responsible for buffering packets received from packet forwarder 38a and scheduling their transmission across the TDM switching fabric 50 by way of backplane mapper 42a. The traffic manager 40a maintains a set of virtual output queues (VOQs) 44a for the purpose of buffering received packets. In the present embodiment this set of queues consists of two VOQs 44a-1 and 44a-2. Each VOQ 44a-1 and 44a-2 acts as a “virtual output” representation of an associated egress port. Queue 44a-1 is associated with egress port 90a while queue 44a-2 is associated with egress port 90b. Each VOQ stores packets destined for the egress port with which it is associated. The use of multiple VOQs is intended to eliminate “Head Of Line (HOL) blocking”. HOL blocking refers to the delaying of packets enqueued behind a packet at the head of a queue, which packet is blocked because it is destined for a congested egress port. HOL blocking may occur when a single queue is used to buffer packets for multiple egress ports. HOL blocking is undesirable in that it may unnecessarily delay packets whose destination egress ports may be uncongested.

Traffic manager 40a additionally performs statistical multiplexing on received packets. As is known in the art, statistical multiplexing refers to the identification and elimination of idle packets in order to free up bandwidth for packets containing valid (non-idle) data.

Traffic manager 40a is also responsible for discarding packets (if necessary) based on any congestion occurring the switching fabric 50.

Backplane mapper 42a is a component responsible for receiving packets from traffic manager 40a and transmitting them to egress port 90a or 90b over switching fabric connections 52 and 54. Backplane mapper 42a maintains low-level information regarding the composition of connections 52 and 54 from multiple physical paths within TDM switching fabric 50. In the present embodiment, physical paths are combined to create connections using virtual concatenation. As is known in the art, virtual concatenation allows a group of physical paths in a SONET network (individually referred to as “members”) to be effectively grouped to create a single logical connection. A connection created using virtual concatenation may be likened to a physical pipe comprised of multiple fixed-size, smaller pipes (members). The purpose of virtual concatenation is to create connections over which large SONET data payloads may be efficiently transmitted. Efficient transmission is achieved by breaking the large payload into fragments and transmitting the fragments in parallel over the members (referred to as “spraying” the data across the connection). Virtual concatenation is defined in ITU-T recommendation G.707/Y.1322 “Network Node Interface for the Synchronous Digital Hierarchy (SDH)” (October 2000), which is hereby incorporated by reference hereinto.

Backplane mapper 42a coordinates connection capacity adjustments with a backplane mapper at an egress port at the other end of each connection to which ingress port 30a is connected. Steps performed by the backplane mapper 42a in order to effect connection capacity adjustments may include temporarily ceasing traffic flow over a connection (i.e. stopping all flow through the overall pipe), adding or removing a member (i.e. adding/removing a smaller pipe to/from the overall pipe), and resuming transmission over the connection (i.e. resuming flow through the resized overall pipe). Coordination of capacity adjustments between ingress and egress ports is achieved through transmission of out of band control messages over the interconnecting connection. Backplane mapper 42a operates under the control of ingress traffic controller 46a (described below).

The backplane mapper 42a is additionally responsible for receiving circuit-switched voice traffic forwarded by channel separator 34a and directing that traffic to a connection for transmission to an egress port.

The ingress traffic controller 46a is a component generally responsible for ensuring that the capacity of each connection connected to ingress port 30a (i.e. connections 52 and 54) is maintained at a level commensurate with the characteristics of the packet traffic currently flowing through the connection. The ingress traffic controller 46a performs three main tasks. First, it monitors the utilization of connections 52 and 54 as well as the fill of VOQs 44a-1 and 44a-2 used to store packets destined for transmission across those connections. Second, based on this monitoring, the ingress traffic controller 46a periodically generates requests for connection capacity adjustments, transmits the requests to the bandwidth manager 60, and processes responses from the bandwidth manager 60 which either authorize or decline the requests. Third, the ingress traffic controller 46a actually adjusts the capacity of connections 52 and/or 54 if the adjustments are authorized by bandwidth manager 60.

For the purpose of adjusting the capacity of connections, the ingress traffic controller 46a executes an algorithm known as the Link Capacity Adjustment Scheme (LCAS). As known to those skilled in the art, LCAS facilitates adjustment of the capacity of a virtually concatenated group of paths in a SONET network in a manner that does not corrupt or interfere with the data signal (i.e. in a manner that is “hitless”). The ingress traffic controller 46a executes LCAS logic, and on the basis of this logic, instructs the backplane mapper 42a to actually make the capacity adjustments. The backplane mapper 42a handles the low-level signalling involved in making the adjustments. LCAS is defined in ITU-T recommendation G.7042/Y.1305 “Link Capacity Adjustment Scheme (LCAS) For Virtual Concatenated Signals” (February 2004), which is hereby incorporated by reference hereinto.

Backplane mapper 42a and ingress traffic controller 46a may be co-located on a single card referred to as the “Fabric Interface Card”.

Turning to the first egress port 90a, it may be seen in FIG. 2 that the port 90a has many components that are similar to the components of ingress port 30a, including: a backplane mapper 70a, a traffic manager 76a, a packet forwarder 80a, and an egress PHY 74a. Egress port 90a also has an egress traffic controller 84a, a packet processor 82a, and a channel integrator 72a The other egress port 90b has a similar structure.

Backplane mapper 70a maintains low-level information regarding the composition of each connection to which ingress port 30a is connected (i.e. connections 52 and 56) from multiple physical paths within TDM switching fabric 50. That is, backplane mapper 70a understands how the physical paths are virtually concatenated to create connections 52 and 56. In addition, backplane mapper 70a facilitates the coordination of connection capacity adjustments with ingress port backplane mappers 42a and 42b at the other ends of connections 52 and 56. Operation of backplane mapper 70a in this regard is governed by out of band control messages received over connections 52 and 56.

The backplane mapper 70a is additionally responsible for receiving circuit-switched voice traffic from the TDM switching fabric 50 and directing that traffic to channel integrator 72a for ultimate transmission to a next node in network 10 (FIG. 1). Backplane mapper 70a operates under the control of egress traffic controller 84a.

Traffic manager 76a is a component responsible for buffering packets received from backplane mapper 70a and forwarding packets to packet forwarder 80a for eventual transmission to a next node in network 10 (FIG. 1). The traffic manager 40a maintains a queue 78a for the purpose of buffering received packets. Packets stored in queue 78a may have been received from any ingress port. Prior to storing packets in queue 78a, traffic manager 76a performs statistical multiplexing on received packets.

Packet forwarder 80a is a component generally responsible for receiving packets from the traffic manager 76a and forwarding the packets to packet processor 82a.

Egress PHY 74a is a component responsible for the low-level signalling involved in transmitting TDM-based voice and data traffic over network link 22e using the STS-1/OC-1 interfaces.

Egress traffic controller 84a is a component which supports the maintenance of switching fabric connections 52 and 56 at levels commensurate with the amount of data traffic currently flowing through the connections.

Channel integrator 72a is a component responsible for two combining circuit-switched voice traffic received from backplane mapper 70a with packet-switched data traffic from packet processor 82a into a single stream.

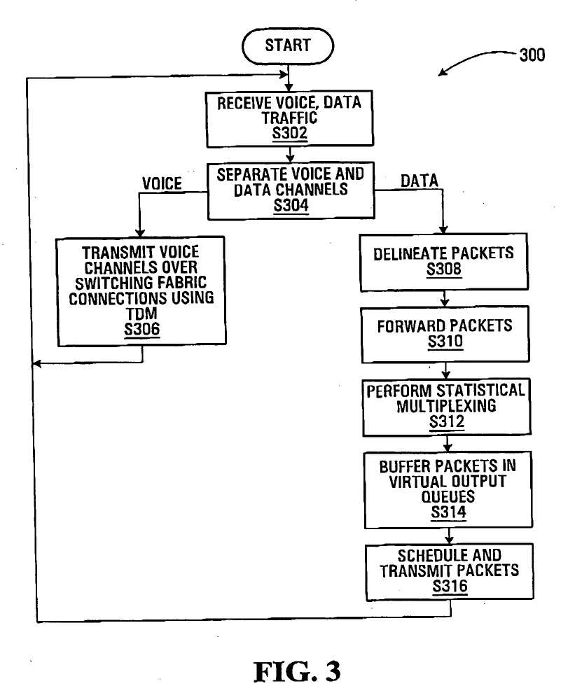

Operation of the switch 20c is described in FIGS. 3 to 7, with additional reference to FIG. 2.

It is initially assumed that connections 52, 54, 56 and 58 (FIG. 2) have been pre-configured in the TDM switching fabric 50 before any voice or data traffic has begun to flow through the switch 20c. The capacity of each connection is initially set to a value that is low compared to the overall bandwidth of the TDM switching fabric 50. This may be achieved by configuring each connection 52, 54, 56 and 58 to initially be comprised of a single “member” path (which in the present embodiment has a capacity of 51.84 megabits/sec). This initial capacity represents the minimal amount of connectivity between ingress ports 30a, 30b and egress ports 90a, 90b of switch 20c; the capacity of each connection 52, 54, 56 and 58 will not drop below this minimal capacity at any time during switch operation. The purpose of maintaining this minimal amount of connectivity between ingress and egress ports is to facilitate fast switching of data from any ingress port to any egress port, to support switching of individual packets to any destination egress port. Any remaining bandwidth in TDM switching fabric 50 that has not been allocated to any of connections 52, 54, 56 or 58 (which initially represents the majority of the fabric capacity) is allocated to the switching fabric's bandwidth pool for possible future use.

Referring to FIG. 3, ingress port operation 300 for receiving and processing voice and data traffic is illustrated. Operation 300 is occurs at each ingress port 30a and 30b.

With reference to operation at ingress port 30a FIG. 2), voice and data traffic is initially received at ingress PHY 32a in the form of OC-1/STS-1 signals (S302). Traditional circuit-switched traffic is separated from data traffic on a VT-1.5 channel by VT-1.5 channel basis at channel separator 34a (S304). Subsequent processing depends on whether the traffic is voice or data.

In the case of voice, the separated voice channels are forwarded to backplane mapper 42a, which transmits the voice channels over the TDM switching fabric 50 using TDM, in a conventional manner.

In the case of data, the separated data channels are forwarded to packet delineator 36a, which delineates the channels into individual packets using HDLC, Ethernet delineation, or GFP delineation for example (S308).

Delineated packets are forwarded to packet forwarder 38a. Packet forwarder 38a ultimately forwards packets to traffic manager 40a.

Traffic manager 40a performs statistical multiplexing on packets received from packet forwarder 38a (S312). Statistical multiplexing may be necessary if TDM switching fabric 50 is oversubscribed. As is well known in the art, “oversubscription” refers to a commitment made by a transmission system (here, TDM switching fabric 50) to provide more bandwidth than the system actually has to provide, such that the system would be incapable of supporting transmission of all data streams if the streams all required the bandwidth simultaneously. Switching fabric 50 may be oversubscribed to promote greater use of its capacity, if it is expected that much of the data traffic received by the ingress ports 30a and 30b will be idle packets. Statistical multiplexing may also be advisable to limit traffic flowing between each ingress port 30a and 30b and the fabric 50, which may also be limited (e.g. to 2 gigabits/sec per ingress port).

Following statistical multiplexing, the remaining packets are queued in VOQs 44a-1 and 44a-2 based on the destination address (DA) encoded within the packets (S314). The DA may be encoded according to conventional packet-based standards. Thereafter, the traffic manager 40a schedules transmission of the packets over connections 52 and 54 (S316).

Operation 300 repeats (occurs continuously) throughout switch operation.

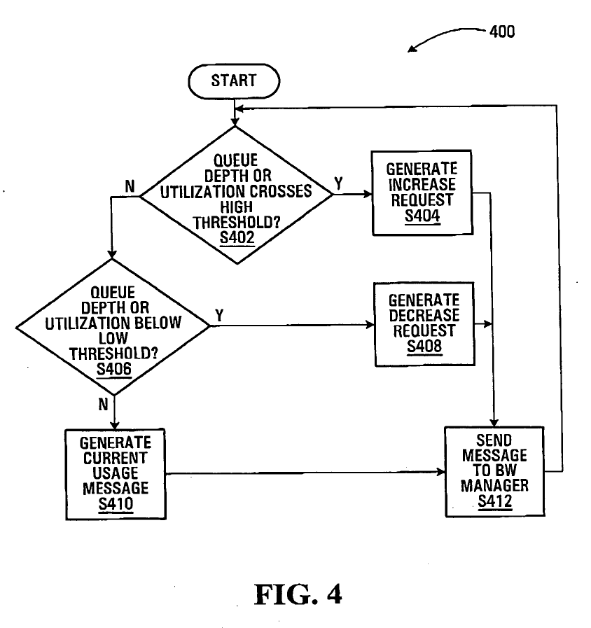

Turning to FIG. 4, ingress port operation 400 for generating requests for connection capacity adjustments is illustrated. Operation 400 occurs periodically at each ingress port 30a and 30b , for each connection to which the ingress port is connected.

With reference to operation 400 at ingress port 30a for a first connection 52 (FIG. 2), it is assumed that the ingress traffic controller 46a continually monitors utilization of the connection 52 as well as the fill of VOQ 44a-1 (i.e. the degree to which the VOQ 44a-1 is filled) during a sliding time interval.

Monitoring of the utilization of connection 52 may be achieved using a rate estimation algorithm which complies with the proposed method defined by IEEE P802.17/D2.5, which is hereby incorporated by reference hereinto. This rate estimation algorithm has two parts: an aging interval function and a low pass filter function. The aging interval function refers to the determination of the average amount of connection capacity used versus the amount of connection capacity available during the sliding time interval. The average capacity may be determined by summing N samples of used capacity versus available capacity during the time window and dividing by N for example. It will be appreciated that the averaging of N samples tends to “average out” the burstiness of the data traffic during the interval. The low pass filter function refers to the weighting of more recent samples in the time interval more heavily than less recent samples.

Monitoring of the fill of VOQ 44a-1 during the sliding time interval may entail determining the used capacity of the queue versus available capacity of the queue during the interval. Multiple samples may be taken during the interval, with the sample representing the highest fill during the interval being used.

If either the utilization of connection 52 or the determined fill of VOQ 44a-1 crosses a “high” threshold (S402) (which threshold may be independently set for connection utilization versus buffer fill), the ingress traffic controller 46a generates a request for increased capacity for the connection 52 (S412) and forwards the request to bandwidth manager 60 (S412) over control interface 59 (FIG. 2). The request does not specify a desired amount of additional bandwidth, but rather simply indicates that an increase in bandwidth is desired. In terms of the fill of VOQ 44a-1, the “high” threshold may be deemed to be exceeded if the fill of VOQ 44a-1 has exceeded a particular percentage of buffer capacity, such as 70% to 80% of capacity for example, at any time during the interval. Multiple samples may be taken during the interval to estimate the duration during the interval for which the “high” threshold of VOQ 44a-1 was exceeded. Duration may be estimated in order to be able to prioritize connection capacity adjustment requests for VOQs which have been over threshold for longer periods of time.

If neither the utilization of connection 52 nor the fill of VOQ 44a-1 has crossed the “high” threshold (S402), an assessment is then made as to whether either of the utilization of connection 52 or the fill of VOQ 44a-1 has dropped below a “low” threshold (S406) (which threshold may again be independently set for connection utilization versus buffer fill). If this assessment is made in the affirmative, the ingress traffic controller 46a generates a request for reduced capacity for the connection 52 (S408) and forwards the request to bandwidth manager 60 (S412) over control interface 59 (FIG. 2). The request does not specify a desired amount of bandwidth to be removed, but rather simply indicates that a decrease in bandwidth is desired. In respect of the fill of VOQ 44a-1, the “low” threshold may be deemed to be exceeded if the fill of VOQ 44a-1 has dropped below a particular percentage of buffer capacity, such as 20% to 30% of capacity for example, at any time during the interval. As with the “high” threshold determination, multiple samples may be taken during the interval to estimate the duration during the interval for which the “low” threshold of VOQ 44a-1 was exceeded, in this case to facilitate prioritization of connection capacity adjustment requests for VOQs which have been below threshold for a longer period of time.

It will be appreciated that the utilization of connection 52 and fill of VOQ 44a-1 are each indicative of congestion in connection 52, albeit in different ways. It will also be appreciated that the high and low thresholds for connection utilization and VOQ fill referenced above cumulatively define an acceptable range of congestion for the connection 52.

If the assessment of S406 is in the negative, the ingress traffic controller 46a nevertheless generates a message (S408) which is forwarded to bandwidth manager 60 (S412) over control interface 59. In this case the message simply reports current connection 52 utilization and buffer 44a-1 fill.

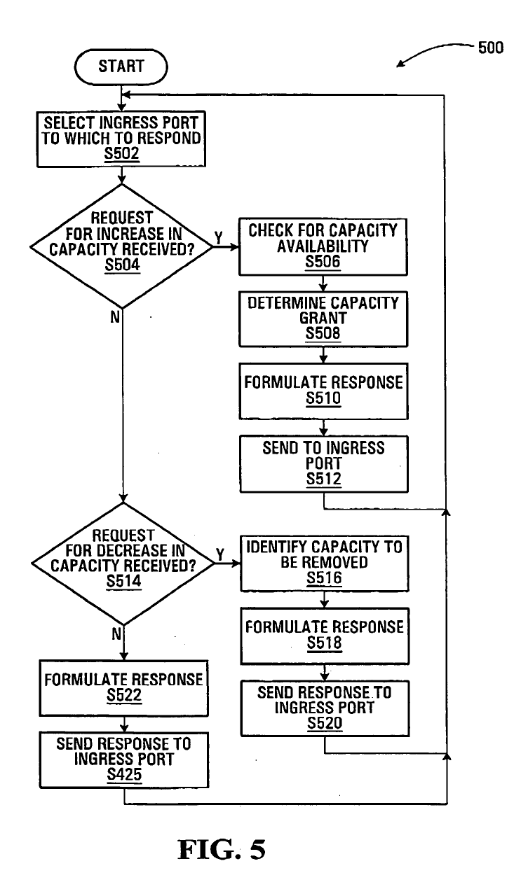

Referring now to FIG. 5, operation 500 of bandwidth manager 60 (FIG. 2) for responding to connection capacity adjustment requests is illustrated. Operation 500 occurs periodically at bandwidth manager 60.

Initially, an ingress port to which to respond is selected (S502). Because ingress ports 30a and 30b each periodically send messages to bandwidth manager 60 requesting an increase or decrease in capacity for a connection (or to report current connection utilization and associated buffer fill if no capacity increase/decrease is needed), at any given time a number of such messages may be outstanding for one or more ingress ports at bandwidth manager 60. The purpose of the selection of S502 is to identify the ingress port whose message should be processed next.

Selection of an ingress port message to process in S502 may be governed by a scheduling technique such as the Negative Deficit Round Robin (NDRR) technique. In this technique, a deficit indicator is maintained for each ingress port. If the deficit indicator for a particular ingress port is within some predetermined range, then the ingress port is considered to be running a surplus of packets and is considered for connection capacity adjustment; otherwise, the ingress port is considered to be running a deficit of packets and is not considered for connection capacity adjustment. The NDRR technique is described in copending U.S. patent application Ser. No. 10/021,995 entitled APPARATUS AND METHOD FOR SCHEDULING DATA TRANSMISSIONS IN A COMMUNICATION NETWORK, filed on Dec. 13, 2001 in the names of Norival R. Figueira, Paul A. Bottorff and Huiwen Li, which application is hereby incorporated by reference hereinto.

Once an ingress port message has been selected, further operation depends on whether the message comprises a request for increased capacity, a request for decreased capacity, or a report of current connection utilization and buffer fill.

If the ingress port message comprises a request for increased capacity (S504), the bandwidth manager 60 communicates with the TDM switching fabric 50 in order to ascertain whether an unused chunk of bandwidth is available in the bandwidth pool. In the present embodiment, the size of the bandwidth chunk for which availability is ascertained is 51.84 megabits/sec (corresponding to an STS-1 signal). Based on the ascertained availability of the bandwidth chunk, a capacity grant is determined (S508). The grant will either identify the particular chunk of bandwidth that is available for addition to the connection, or it will indicate that no bandwidth chunk is presently available. A response message is formulated to report the determined grant (S510), and the message is sent to the requesting ingress port over control interface 59 (S512).

If the ingress port message comprises a request for decreased capacity (S514), the bandwidth manager 60 communicates with the TDM switching fabric 50 in order to identify which 51.84 megabits/sec chunk of bandwidth (i.e. which “member”) presently forming part of the relevant connection should be removed from the connection. A response message indicating the identified chunk of bandwidth that should be removed is formulated (S518), and the message is sent to the requesting ingress port over control interface 59 (S520).

If the ingress port message comprises a report of current connection utilization and buffer fill the bandwidth manager 60 simply formulates a response message echoing this information back to the ingress port for confirmation purposes (S522), and the response message is sent to the requesting ingress port over control interface 59 (S524).

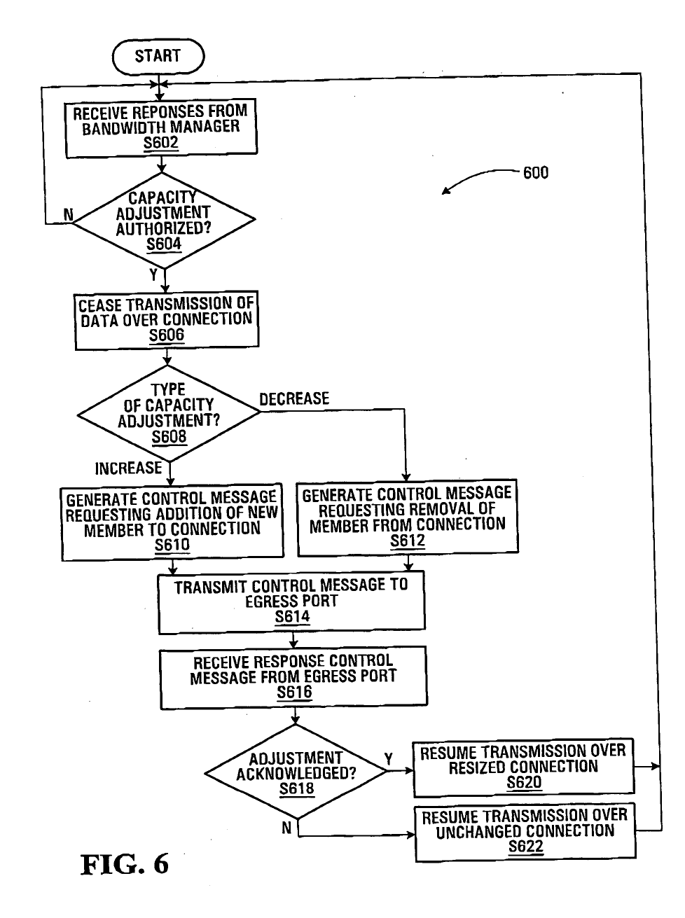

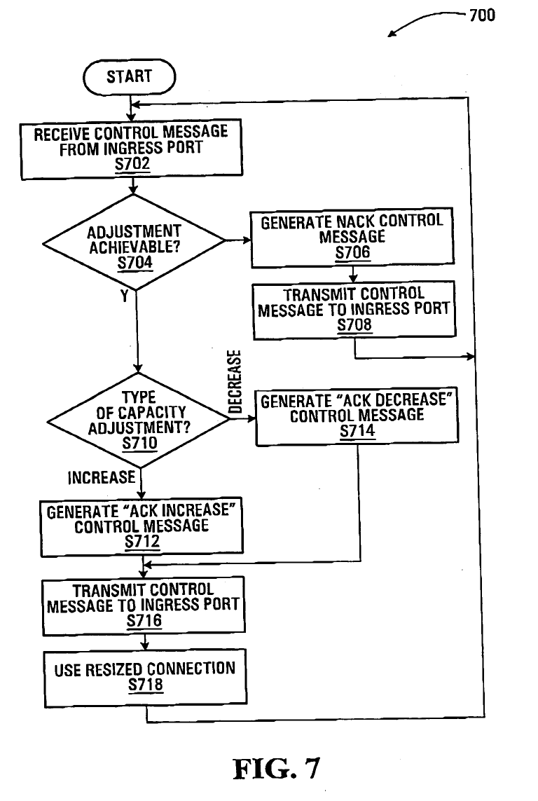

Turning to FIG. 6, operation 600 at an ingress port for processing response messages from the bandwidth manager 60 is illustrated. Operation 600 occurs periodically at each ingress port 30a and 30b (FIG. 2), and includes operation for coordinating connection capacity adjustments with an egress port. Operation 600 will be described in conjunction with the operation 700 (FIG. 7) of an egress port for effecting a connection capacity adjustment at the instruction of a connected ingress port.

Referring to operation 600 at ingress port 30a for a first connection 52 (FIG. 2), a response message regarding connection 52 is initially received at the ingress traffic controller 46a from bandwidth manager 60 (S602). If the message does not authorize a connection capacity adjustment (S604) (e.g., if the message denies an earlier request made by ingress port 30a for additional capacity), the ingress traffic controller 46a may instruct the traffic manager 40a to discard packets as necessary for avoiding congestion, and operation 600 awaits the next message from bandwidth manager 60 (S602).

If the message authorizes a connection capacity adjustment (S604), the ingress port 30a commences operation of the LCAS algorithm for adjusting the capacity of the connection 52. The LCAS algorithm logic, which executes on the ingress traffic controller 46a (FIG. 2), initially instructs the backplane mapper 42a to cease transmission of data over the connection 52 (S606). The backplane mapper 42a ceases transmission of packets on a packet boundary in order to avoid transmission errors which may occur if the transmission of a packet is interrupted, so that connection capacity adjustment will be hitless.

If the authorized capacity adjustment is an increase in connection size (S608, S610), a control message instructing the backplane mapper 70a at the egress side of connection 52 to add a specified new member to the connection 52 is generated by the backplane mapper 42a. The new member specified in the message is the bandwidth chunk which was identified in the response message from the bandwidth manager 60.

If, on the other hand, the authorized capacity adjustment is a decrease in connection size (S608, S610), a control message is generated by the backplane mapper 42a instructing the backplane mapper 70a at the egress side of connection 52 to remove the specified member from the connection 52.

The control message is then transmitted to the egress port 90a over the connection 52 (S614).

Turning to FIG. 7, the control message is received at egress port 90a at backplane mapper 70a (S702). If the egress port 90a for any reason cannot honor the requested capacity adjustment (S704), a negative-acknowledge (“NACK”) control message is generated (S706) and transmitted over connection 52 back to the ingress port 30a (S708).

If the egress port 90a is able to honor the requested capacity adjustment (S704), then depending upon whether the control message requests the addition of a new member or removal of an existing member from the connection 52 (S710), an appropriate control message is generated to acknowledge (“ACK”) the capacity increase (S712) or capacity decrease (S714) respectively. The control message is transmitted over connection 52 to the ingress port 30a (S716). The egress port 90a then begins using the resized connection (S718). This may involve synchronizing with the ingress port 30a to ensure that the egress port's interpretation of bits received over the updated set of members comprising the resized connection 52 will be consistent with the ingress port's transmission of the bits.

Referring back to FIG. 6, the ACK or NACK control message is received at the ingress port 30a from the egress port 90a (S616). If the received control message is an ACK message acknowledging that the backplane mapper 70a was successful in making the requested adjustment (S618), transmission is resumed over the resized connection in accordance with the LCAS algorithm (S620). Otherwise, transmission is resumed over the unchanged connection (S622). Operation 600 then awaits the next message from bandwidth manager 60 (S602).

As should now be apparent, operation 400, 500, 600 and 700 illustrated in FIGS. 4 to 7 results in dynamic allocation of the bandwidth of TDM switching fabric 50 among connections 52, 54, 56 and 58 so that connections deemed to be in greater need of bandwidth are allocated greater amounts of bandwidth. The allocation may change over time, e.g., due to the burstiness of data traffic on certain connections or simply due to the demands arising from time-of-day traffic shift. The minimal connectivity which is maintained for each connection between an ingress port and an egress port facilitates fast “any-to-any” switching of data traffic on a packet-by-packet basis. Moreover, the statistical multiplexing that is applied to data traffic tends to reduce demands on TDM switching fabric 50, in view of fact that idle packets may be removed from the flows. The switch 20c is also versatile, being capable of receiving traditional circuit-switched traffic for conventional TDM switching switch in addition to data traffic for packet-based processing and TDM switching.

Upgrading (or “migrating”) a conventional TDM switch to become a packet-aware TDM switch with dynamically configurable switching fabric connections as described herein may entail upgrading ingress card hardware to support packet-awareness (e.g. adding a channel separator, packet delineator, packet forwarder, traffic manager, and ingress port traffic controller to each ingress port) and by making similar modifications to egress port hardware. Conventional bandwidth manager components may also require modification to support dynamic examination of switching fabric bandwidth status and to add functionality for responding to connection capacity adjustment requests. A conventional TDM switching fabric may require modification comprising a software upgrade so that the fabric will be capable of maintaining a bandwidth pool and of dynamically reallocating bandwidth as described. An upgraded TDM switch should be capable of implementing the operation described in FIGS. 3 to 7 or analogous operation.

As will be appreciated by those skilled in the art, modifications to the above-described embodiments can be made without departing from the essence of the invention For example, although the described embodiment is capable of receiving traditional circuit-switched traffic for conventional switching through the TDM switch in addition to data traffic for packet-based switching of traffic through the TDM switch, some embodiments may not be capable of conventional TDM switching of circuit-switched traffic. Such switches may for example be employed in networks in which only data traffic flows. Embodiments of this type would not require channel separator components in their ingress ports nor channel integrator components in their egress ports.

Assuming that an embodiment is in fact capable of switching traditional circuit-switched traffic through the TDM switch in addition to data traffic, the data and voice channels separated by the channel separator component of the ingress port may be of a lower level of granularity than SONET VT-1.5 channels.

In another possible alternative, the VOQs employed in ingress port traffic manager components may have sub-queues for buffering packets on a per egress port, per flow, and per class of service (QoS) basis. These sub-queues may be included to support prompt and consistent delivery of high priority traffic (e.g. traffic with a high QoS level, such as voice-over-IP traffic) through the avoidance of significant delay (time required for a packet to be transmitted from an ingress port to an egress port) and jitter (packet-to-packet variation in delay), by allowing such high priority traffic to be readily identified. The use of sub-queues may also be advantageous if the ingress port is required to discard any packets, since the sub-queues may also facilitate identification of low-priority packets, which may be discarded first.

Alternative switch embodiments may employ a TDM switching fabric which does not maintain a pool of unused bandwidth. Rather, unused bandwidth may be apportioned among some or all of the existing connections. In this case, any increase in the bandwidth of a particular switching fabric connection would entail a corresponding decrease in bandwidth of another switching fabric connection.

Further, while the ingress ports of the described embodiment generate connection capacity adjustment requests based on either of a high utilization of the connection or a large amount of buffered packets destined for the connection (or alternatively based on either of a low utilization of the connection or a small amount of buffered packets destined for the connection), alternative embodiments may base connection capacity adjustment requests upon other indicators of congestion of the connection. For instance, alternative embodiments may base connection capacity adjustment requests solely on measured connection utilization or solely on measured buffer fill. Alternatively, other embodiments may generate a connection capacity adjustment requests only if both of the measured connection utilization and the measured buffer fill exceed certain upper or lower limits.

Finally, the interfaces supported by ingress PHY and egress PHY components of alternative embodiments may include DS-n/E-n/J-n, OC-n, and Ethernet for example. Moreover, alternative embodiments may conform to the SDH standard, which is the international equivalent of SONET.

Other modifications will be apparent to those skilled in the art and, therefore, the invention is defined in the claims.

What is claimed is:

1. Apparatus for use with a time division multiplexing (TDM) switch, comprising:
an ingress port for connection to a TDM switching fabric, said ingress port comprising a controller for obtaining an indication of congestion for a connection through said TDM switching fabric and for, if said congestion indication falls outside an acceptable range, sending a request to adjust a capacity of said connection.

2. The apparatus of claim 1 wherein said ingress port flyer comprises an input buffer for packets associated with said connection and wherein said congestion indication comprises an indication of a degree to which said input buffer is filled.

3. The apparatus of claim 1 wherein said congestion indication comprises a utilization of said connection.

4. The apparatus of claim 1 wherein, if said congestion indication indicates congestion above said acceptable range, said sending comprises sending a request for an increase in capacity.

5. The apparatus of claim 1 wherein, if said congestion indication indicates congestion below said acceptable range, said sending comprises sending a request for a decrease in capacity.

6. The apparatus of claim 1 further comprising:
a bandwidth manager for receiving said request, for determining whether said capacity adjustment is realizable, and for responding to said request based on said determining.

7. The apparatus of claim 6 wherein said determining comprises identifying a portion of bandwidth of said TDM switching fabric to be added to or removed from said connection.

8. A switch comprising:
a plurality of ingress ports capable of receiving and distinguishing packets, said receiving and distinguishing resulting in arrived packets;
a plurality of egress ports;
a switching fabric having persistent connections interconnecting each of said ingress ports with each of said egress ports, said connections capable of transmitting said arrived packets from said ingress ports to said egress ports using time division multiplexing, each of said connections having a capacity; and
a controller for automatically adjusting the capacity of a connection in said switching fabric based on a measure of congestion for said connection.

9. The switch of claim 8 wherein said measure of congestion comprises a utilization of said connection.

10. The switch of claim 9 wherein said utilization of said connection is a proportion of the capacity of said connection that is used for carrying packet traffic during a time interval.

11. The switch of claim 9 wherein said utilization of said connection is an average proportion of the capacity of said connection that is used for carrying packet traffic during a time interval.

12. The switch of claim 8 wherein each of said ingress ports has a plurality of queues, each of said queues for storing arrived packets destined for a particular egress port, and wherein measure of congestion for said connection comprises a fill of the queue for storing arrived packets that are destined for the egress port with which said connection is interconnected.

13. The switch of claim 8 wherein said controller for automatically adjusting the capacity of a connection employs the Link Capacity Adjustment Scheme.

14. The switch of claim 8 wherein at least one of said ingress ports is capable of receiving circuit switched traffic destined for an egress port and wherein said switching fabric is capable of transmitting said circuit switched traffic to said egress port over a connection using time division multiplexing.

15. The switch of claim 8 wherein at least one of said plurality of ingress ports is capable of applying statistical multiplexing to said arrived packets.

16. Apparatus for use in time division multiplexing (TDM) switching of bursty data traffic, comprising:
a switching fabric capable of providing persistent connections interconnecting each of a plurality of ingress ports with each of a plurality of egress ports, said connections for transmitting packets received at said ingress ports to said egress ports using time division multiplexing, each of said connections having a capacity that is automatically adjustable based on an indication of congestion for said connection.

17. A method of switching packets over a switching fabric using time division multiplexing comprising:
receiving packets at one or more ingress ports;
for each packet received at an ingress port:
determining a destination egress port for said packet; and
using time division multiplexing, transmitting said packet over a switching fabric connection interconnecting said ingress port with said destination egress port; and
for each connection in said switching fabric interconnecting an ingress port with an egress port:
periodically measuring congestion of the connection; and
automatically adjusting a capacity of said connection based on said measuring.

18. The method of claim 17 wherein said measuring comprises measuring a utilization of the connection.

19. The method of claim 18 wherein said measuring a utilization of the connection comprises measuring a proportion of the capacity of the connection that is used for carrying packet traffic during a time interval.

20. The method of claim 17 further comprising, for each packet received at an ingress port, after said determining a destination egress port, storing said packet in a buffer associated with said egress port, and wherein said measuring comprises measuring a degree to which said buffer is filled.

21. The method of claim 17 wherein said automatically adjusting a capacity of a connection comprises adjusting a capacity of a connection using the Link Capacity Adjustment Scheme (LCAS).

22. The method of claim 17 further comprising:
receiving circuit switched traffic at an ingress port; and
transmitting said circuit switched traffic over a connection in said switching fabric using time division multiplexing.

23. The method of claim 17 further comprising, for each packet received at an ingress port, applying statistical multiplexing to said packet.

24. A computer-readable medium storing instructions which, when executed by a switch, cause said switch to:
receive packets at one or more ingress ports;
for each packet received at an ingress port:
determine a destination egress port for said packet; and
using tie division multiplexing, transmit said packet over a switching fabric connection interconnecting said ingress port with said destination egress port; and
for each connection in said switching fabric interconnecting an ingress port with an egress port:
periodically measure congestion of the connection; and
automatically adjust a capacity of said connection based on the periodic measuring.

25. The computer-readable medium of claim 24 wherein said periodic measuring comprises measuring utilization of the connection.

26. The computer-readable medium of claim 25 wherein said utilization of the connection comprises a proportion of the capacity of the connection that is used for carrying packet traffic during a time interval.

27. The computer-readable medium of claim 24 said wherein said instructions further cause said switch to, for each packet received at an ingress port, after said determining a destination egress port, store said packet in a buffer associated with said egress port, and wherein said periodic measuring comprises measuring a degree to which said buffer is filled.

28. The computer-readable medium of claim 24 wherein said instructions further cause said switch to use the Link Capacity Adjustment Scheme (LCAS) when automatically adjusting the capacity of a connection in said switching fabric.

29. The computer-readable medium of claim 24 wherein said instructions further cause said switch to:
receive circuit switched traffic at an ingress port; and
transmit said circuit switched traffic over a connection in said switching fabric using time division multiplexing.

30. The computer-readable medium of claim 24 wherein said instructions further cause said switch to, for each packet received at an ingress port, apply statistical multiplexing to said packet.
